(19) United States
(12) Patent Application Publication
(10) Pub. No.: US 2024/0279769 A1
(43) Pub. Date: Aug. 22, 2024

(54) LITHIUM RECLAMATION FROM GLASS-BASED MATERIALS BY WATER-DRIVEN EXTRACTION

(71) Applicant: CORNING INCORPORATED, CORNING, NY (US)

(72) Inventors: Deqiu Fan, Painted Post, NY (US); Qiang Fu, Painted Post, NY (US); Yuhui Jin, Painted Post, NY (US); Grace MaryAlice Yu Leahy, Corning, NY (US); Cedrick Alexander O’Shaughnessy, Painted Post, NY (US)

(21) Appl. No.: 18/443,862

(22) Filed: Feb. 16, 2024

Related U.S. Application Data
(60) Provisional application No. 63/447,503, filed on Feb. 22, 2023.

(51) Int. Cl. C22B 7/00; C03C 3/062; C03C 3/083; C22B 1/00

(52) U.S. Cl. CPC C22B 7/008; C03C 3/062; C03C 3/083; C22B 1/005

(57) ABSTRACT

A process for recovering lithium from lithium-containing glass based materials includes providing lithium-containing particles comprising the lithium-containing glass-based materials; contacting the lithium-containing particles with calcium salts in water, wherein the contacting causes leaching of at least a portion of lithium ions from the lithium-containing particles into a first leachate of the first mixture; separating the first mixture into the first leachate and a first residue; and recovering lithium from the first leachate.

This application claims the benefit of priority under 35 U.S.C. § 119 of U.S. Provisional Application Ser. No. 63/447,503 filed on Feb. 22, 2023, the content of which is relied upon and incorporated herein by reference in its entirety.

### BACKGROUND

### Field

The present specification generally relates to glass-based materials, and more particularly to methods of recovering lithium from glass-based materials.

### Technical Background

Lithium presents the highest sublimation energy, electronegativity, and ionization energy and the smallest ionic radius of the alkali group metals, which makes lithium a desirable option for the cathode material for rechargeable high-power-density batteries. After batteries, the glass and ceramic industries are the second largest consumers of lithium. The addition of lithium in ceramics lowers the firing temperatures and thermal expansion and increases the strength of ceramic bodies. In lithium-containing glasses, the highly mobile lithium atoms offer high-ion-diffusivity, which enables the glass to be chemically strengthened through ion exchange. This chemical strengthening process can provide good drop performance and mechanical properties to the glass.

### SUMMARY

A first aspect of the present disclosure may be directed to a process for recovering lithium from lithium-containing glass-based materials. The process may comprise providing lithium-containing particles comprising the lithium-containing glass-based materials; contacting the lithium-containing particles with calcium salts in water at a first leaching temperature for a first leaching time to produce a first mixture, wherein the contacting causes leaching of at least a portion of lithium ions from the lithium-containing particles into a first leachate of the first mixture; separating the first mixture into the first leachate and a first residue; and recovering lithium from the first leachate.

In a second aspect, according to the first aspect, the lithium-containing particles may comprise lithium-containing glass ceramic.

In an third aspect, according to any one of aspects 1-2, the lithium-containing glass ceramics may comprise one or more of a lithium disilicate phase, a petalite bearing phase, a β-spodumene phase, or combinations thereof.

In a fourth aspect, according to any one of aspects 1-3, the lithium-containing glass-ceramic may not include a zirconium titanate crystalline phase.

In a fifth aspect, according to any one of aspects 1-4, the lithium-containing glass-ceramic may not include a β-quartz phase.

In an sixth aspect, a process for recovering lithium from lithium-containing glass-based materials may comprise providing lithium-containing particles comprising the lithium-containing glass-based materials; contacting the lithium-containing particles with calcium salts in water at a first leaching temperature for a first leaching time to produce a first mixture, wherein the contacting may cause leaching of at least a portion of lithium ions from the lithium-containing particles into a first leachate of the first mixture; separating the first mixture into the first leachate and a first residue; and recovering lithium from the first leachate.

In a seventh aspect, according to either one of aspects 1 or 6, the lithium-containing particles may have an acid chemical durability of greater than 15 mg/cm² weight loss after 24 hours of exposure to 5 wt. % HCl, based on the initial weight and surface area of the lithium-containing particles, an alkaline chemical durability of greater than 1.5 mg/cm² weight loss after 6 hours of exposure to 5 wt. % NaOH, based on the initial weight and surface area of the lithium-containing particles, or both.

In an eighth aspect, according to any one of aspects 1 and 6-7, the lithium-containing particles may have less than about 5% crystallinity.

In a ninth aspect, according to any one of aspects 1 and 6-8, the lithium-containing particles may have a composition comprising: from 30 mol % to 85 mol % SiO₂; from 2 mol % to 30 mol % Al₂O₃; from 0 mol % to 20 mol % B₂O₃; from 2 mol % to 20 mol % Li₂O; from 0 mol % to 20 mol % Na₂O; from 0 mol % to 20 mol % K₂O; from 0 mol % to 8 mol % MgO; from 0 mol % to 20 mol % CaO; from 0 mol % to 10 mol % SrO; from 0 mol % to 10 mol % BaO; from 0 mol % to 5 mol % ZrO₂; from 0 mol % to 5 mol % TiO₂; and from 0 mol % to 5 mol % SnO₂.

In a tenth aspect, according to any one of aspects 1 and 6-9, the lithium-containing particles may have a composition comprising: from 30 mol % to 85 mol % SiO₂; from 2 mol % to 30 mol % Al₂O₃; from 0 mol % to 20 mol % B₂O₃; from 2 mol % to 20 mol % Li₂O; from 0 mol % to 20 mol % Na₂O; from 0 mol % to 20 mol % K₂O; from 0 mol % to 20 mol % MgO; from 0 mol % to 20 mol % CaO; from 0 mol % to 10 mol % SrO; from 0 mol % to 10 mol % BaO; from 0 mol % to 0.2 mol % ZrO₂; from 0 mol % to 5 mol % TiO₂; and from 0 mol % to 5 mol % SnO₂.

In an eleventh aspect, according to any one of aspects 1 and 6-10, the lithium-containing particles may comprise less than 8 mol % of a combined weight of MgO and ZrO₂, based on the total moles of glass in the lithium-containing particles.

In a twelfth aspect, according to any one of aspects 1-11, the process may further comprise, while contacting the lithium-containing particles with the calcium salts in the water at the first leaching temperature, condensing water vapor to produce condensed water and returning the condensed water back into contact with the lithium-containing particles and the calcium salts.

In a thirteenth aspect, according to any one of aspects 1-12, the lithium-containing particles may have a median particle size (d50) of from about 10 μm to about 150 μm.

In a fourteenth aspect, according to any one of aspects 1-13, the process may further comprise heat treating the lithium-containing particles at a temperature of from 500° C. to 700° C. prior to contacting the lithium-containing particles with the calcium salts and water, wherein the heat treating removes residual organic compounds from the lithium-containing particles, dries the lithium-containing particles, or both.

In a fifteenth aspect, according to any one of aspects 1-14, the process may remove at least 25% of the lithium from the lithium-containing particles.

In a sixteenth aspect, according to any one of aspects 1-15 the process may remove at least 40% of the lithium from the lithium-containing particles.

In a seventeenth aspect, according to any one of aspects 1-16, the lithium-containing particles may have a composition comprising: from 30 mol % to 85 mol % SiO₂; from 2 mol % to 30 mol % Al₂O₃; from 0 mol % to 20 mol % B₂O₃; from 2 mol % to 20 mol % Li₂O; from 0 mol % to 20 mol % Na₂O; from 0 mol % to 20 mol % K₂O; from 0 mol % to 20 mol % MgO; from 0 mol % to 20 mol % CaO; from 0 mol % to 10 mol % SrO; from 0 mol % to 10 mol % BaO; from 0 mol % to 5 mol % ZrO₂; from 0 mol % to 5 mol % TiO₂; and from 0 mol % to 5 mol % SnO₂.

In a eighteenth aspect, according to any one of aspects 1-17, wherein the first leaching temperature may be from 80° C. to 120° C.

In a nineteenth aspect, according to any one of aspects 1-18, wherein the first leaching time may be from 1 to 12 hours.

In a twentieth aspect, according to any one of aspects 1-19, recovering lithium from the first leachate may comprise precipitating lithium salts from the first leachate.

In a twenty-first aspect, according to any one of aspects 1-20, wherein precipitating lithium salts from the first leachate may comprise adding a precipitating agent to the first leachate, wherein the precipitating agent comprises carbonate salts, phosphate salts, or both.

In a twenty-second aspect, according to any one of aspects 1-21, the first mixture may comprise calcium salts.

In a twenty-third aspect, according to any one of aspects 1-22, a weight ratio of lithium-containing particles to calcium salts in the first mixture may be from 1:1 to 1:8.

In a twenty-fourth aspect, according to any one of aspects 1-23, a weight ratio of solids to liquids in the first mixture may be from 1:5 to 1:15.

In a twenty-fifth aspect, according to any one of aspects 1-24, a pH in the first mixture may be from 10.5 to 12.

In an twenty-sixth aspect, according to any one of aspects 1-25, the process may further comprise heat treating the first residue to form a heat-treated residue comprising partially leached lithium-containing particles and calcium oxide; contacting the heat-treated residue with water at a second leaching temperature for a second leaching time, wherein the contacting causes leaching of lithium ions from the partially leached lithium-containing particles in a second leachate of a second mixture; separating the second mixture into the second leachate and a second residue; and recovering lithium from the second leachate.

In a twenty-seventh aspect, according to aspect twenty-six, wherein the second leaching temperature may be from 80° C. to 120° C.

In a twenty-eighth aspect, according to either of aspects 26 or 27, wherein the second leaching time may be from 1 to 12 hours.

In a twenty-ninth aspect, according to any one of aspects 26-28, recovering lithium from the second leachate may comprise precipitating lithium salts from the second leachate.

In a thirtieth aspect, according to any one of aspects 26-29, wherein precipitating lithium salts from the second leachate may comprise adding a precipitating agent to the second leachate, wherein the precipitating agent comprises carbonate salts, phosphate salts, or both.

In a thirty-first aspect, according to any one of aspects 21-30, the precipitating agent may comprise sodium carbonate, sodium phosphate, or both and the lithium salts comprise lithium carbonate, lithium sodium phosphate, lithium phosphate, or combinations thereof.

In a thirty-second aspect, according to any one of aspects 26-31, the heat treating the first residue may comprise exposing the first residue to a temperature of from 400° C. to 700° C.

In a thirty-third aspect, according to any one of aspects 26-32, the second mixture may comprise calcium salts.

In a thirty-fourth aspect, according to any one of aspects 26-33, a weight ratio of lithium-containing particles to calcium salts in the second mixture may be from 1:1 to 1:8.

In a thirty-fifth aspect, according to any one of aspects 26-34, a weight ratio of solids to liquids in the second mixture may be from 1:5 to 1:15.

In a thirty-sixth aspect, according to any one of aspects 26-35, a pH in the second mixture may be from 10.5 to 12.

In a thirty-seventh aspect, according to any one of aspects 1-36, the calcium salts may comprise CaO.

In a thirty-eighth aspect, according to any one of aspects 26-37, the process may remove at least 75% of the lithium from the lithium-containing particles.

In a thirty-ninth aspect, according to any one of aspects 1-38, the lithium-containing particles may not be heated to a temperature sufficient to cause a change in the phase assemblage of the glass or glass ceramic.

In a fortieth aspect, according to any one of aspects 1-39, the lithium-containing particles may not be heated to a temperature above about 800° C.

These and other aspects, advantages, and salient features will become apparent from the following detailed description, the accompanying drawings, and the appended claims.

### BRIEF DESCRIPTION OF THE DRAWINGS

FIG. 1 depicts a flow chart for a method of recovering lithium from lithium-containing glass-based materials, according to embodiments disclosed and described herein;

FIG. 2 graphically depicts lithium extraction efficiency (y-axis) as a function of time (x-axis) time, according to embodiments disclosed and described herein;

FIG. 3 schematically depicts first and second pass lithium extraction efficiency (y-axis) for extraction of lithium from various compositions (x-axis), according to embodiments disclosed and described herein;

FIG. 4 schematically depicts an X-ray diffraction (XRD) pattern of heat-treated glass fines prior to lithium extraction, according to embodiments disclosed and described herein;

FIG. 5 graphically depicts an XRD pattern of residual glass fines after lithium extraction, according to embodiments disclosed and described herein.

### DETAILED DESCRIPTION

Reference will now be made in detail to embodiments of the method of recovering lithium from glass-based materials, various embodiments of which will be described herein with specific reference to the accompanying drawings. Whenever possible, the same reference numerals will be used throughout the drawings to refer to the same or like parts. In the following detailed description, numerous specific details may be set forth in order to provide a thorough understanding of embodiments described herein. However, it will be clear to one skilled in the art when embodiments may be practiced without some or all of these specific details. In other instances, well-known features or processes may not be described in detail so as not to unnecessarily obscure the disclosure. In addition, like or identical reference numerals may be used to identify common or similar elements. Moreover, unless otherwise defined, all technical and scientific terms used herein have the same meaning as commonly understood by one of ordinary skill in the art to which this disclosure belongs. In case of conflict, the present specification, including the definitions herein, will control.

Although other methods and materials can be used in the practice or testing of the embodiments, certain suitable methods and materials are described herein.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein.

Thus, if a class of substituents A, B, and C are disclosed as well as a class of substituents D, E, and F, and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and/or C; D, E, and/or F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and/or C; D, E, and/or F; and the example combination A-D. This concept applies to all aspects of this disclosure including, but not limited to any components of the compositions and steps in methods of making and using the disclosed compositions. More specifically, the example composition ranges given herein are considered part of the specification and further, are considered to provide example numerical range endpoints, equivalent in all respects to their specific inclusion in the text, and all combinations are specifically contemplated and disclosed. Further, if there are a variety of additional steps that can be performed it is understood that each of these additional steps can be performed with any specific embodiment or combination of embodiments of the disclosed methods, and that each such combination is specifically contemplated and should be considered disclosed.

Moreover, where a range of numerical values is recited herein, comprising upper and lower values, unless otherwise stated in specific circumstances, the range is intended to include the endpoints thereof, and all integers and fractions within the range. It is not intended that the scope of the disclosure be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end-point referred to.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

It is noted that one or more of the claims may utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

As a result of the raw materials and/or equipment used to produce the glass-based materials discussed herein, certain impurities or components that are not intentionally added, can be present in the final glass-based material compositions. Such materials are present in the glass-based material composition in minor amounts and are referred to herein as “tramp materials.”

As used herein, a glass-based material composition having 0 mol % or 0 wt. % of a compound is defined as meaning that the compound, molecule, or element was not purposefully added to the composition, but the composition may still comprise the compound, typically in tramp or trace amounts. Similarly, “iron-free,” “sodium-free,” “lithium-free,” “zirconium-free,” “alkali earth metal-free,” “heavy metal-free” or the like are defined to mean that the compound, molecule, or element was not purposefully added to the composition, but the composition may still comprise iron, sodium, lithium, zirconium, alkali earth metals, or heavy metals, etc., but in approximately tramp or trace amounts.

As used herein, the term “glass ceramic” refers to solids prepared by controlled crystallization of a precursor glass and have one or more crystalline phases and a residual glass phase.

As used herein, the term “glass-based compositions” refers to both glass compositions and glass ceramic compositions.

The crystalline phase assemblages and weight percentages of crystalline phases and residual glass phases are determined based on x-ray diffraction (XRD) using a Rietveld analysis. The XRD spectra were obtained using a D8 ENDEAVOR™ XRD machine available from Bruker and equipped with Cu radiation and a LynxEye detector. The Rietveld analysis based on the XRD spectra were performed using the TOPAS™ version 6 analysis software from Bruker.

Unless otherwise stated, the alkaline chemical durability of the glass-based materials is determined by first producing a disc of the glass-based material. The disc is 31.75 mm in diameter and 3 mm in thickness. The disc is polished on both sides and subsequently weighed. Then, the disc is placed in 5 wt. % NaOH for a period of 6 hours at about 95° C. The disc is then washed, dried, and weighed again. The alkaline chemical durability may be provided as the grams of weight lost per cm² of the surface area of the disc exposed to the NaOH solution.

Unless otherwise stated, the acid chemical durability of the glass-based material is determined by first producing a disc of the glass-based materials. The disc is 31.75 mm in diameter and 3 mm in thickness. The disc is polished on both sides and subsequently weighed. Then, the disc is placed in 5 wt. % HCl for a period of 24 hours at about 95° C. The disc is then washed, dried, and weighed again. The acid chemical durability may be provided as the grams of weight lost per cm² of the surface area of the disc exposed to the HCl solution.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation; and the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Directional terms as used herein—for example up, down, right, left, front, back, top, bottom, vertical, horizontal—are made only with reference to the figures as drawn and are not intended to imply absolute orientation unless otherwise expressly stated.

As previously discussed, lithium is used by the glass and glass ceramic industries, which are the second largest consumers of lithium. During the last few years, the demand for lithium use in batteries has been increasing dramatically due to the trend of more and more electric vehicles on the market. It is projected that the total number of electric vehicles is expected to exceed 30 million by 2025. Today, most of the lithium is produced from brine, sea water, or minerals, or by recycling of spent lithium-ion batteries. The production rate of lithium has been straining due to the rising demand for lithium. As a result of this, the lithium price has been increasing significantly. Given the large amount of lithium used in glass manufacturing, there is a strong demand to recycle lithium, especially from glass-based materials, for further utilization.

Waste glass-based materials (also called cullet in the glass industry) can be generated in almost every step of processing for making commercial glass-based materials. The current practice for cullet recycling is to re-melt the cullet as much as possible if the cullet itself is compositionally stable without contaminations from other sources. However, often, cullet can be contaminated, such as with other glass-based compositions or other compounds, or the cullet may not have a stable composition. For instance, transitioning between two different types of glass is very common during production of glass-based materials. However, the chemical composition of the cullet generated during the transition often lies between the starting and end glass and is not chemically stable. Thus, re-melting such cullet as a batch raw material to produce new glass-based materials can be very challenging. Further, during the finishing stage, cutting fluid and polishing powders are usually used as coolant and polishing agents (such as cerium oxide). Thus, cullet generated from this stage can contain large amounts of organic and inorganic contaminations, which makes re-melting of such cullet directly very difficult or almost impossible. Other times, mixing of cullet with different compositions in a production environment due to poor cullet management can also make reuse very difficult. In the post-customer stage, re-melting the lithium-containing cover and back glasses from retired cell phones directly into making new glass-based materials seems almost impossible at this moment due to poor sorting and contamination. Today, cullet like this would most likely end up in landfill sites.

Therefore, an ongoing need exists for methods of recovering lithium from waste glass-based materials so that the lithium can be reused in the manufacture of glass-based materials. The present disclosure is directed to processes for recovering lithium from waste glass-based materials by using water driven extraction to extract lithium ions from fines comprising the waste glass-based material into an aqueous solution through aqueous solution ion dissociation, followed by precipitation of lithium into lithium carbonate or lithium phosphate.

Water driven extraction of lithium out of the glass-based materials in the presence of a calcium species can be conducted at temperatures of less than about 120° C., such as at about 100° C., and more than about 80% of the lithium may be extracted within two extraction steps. The water driven extraction processes disclosed herein demonstrate wide applicability in recycling lithium-containing glass-based materials, including lithium-containing glass, lithium-containing glass ceramics, or both. The processes disclosed herein can be seamlessly integrated into the commercial processes. Compared with the traditional lithium extraction from minerals and some glass ceramics, there is no need for the high temperature phase transformation and roasting, therefore, the energy consumption and cost of operation can be significantly lower. High purity lithium carbonate produced from this process can be reused in as a lithium oxide precursor for making new glass-based materials. The alkaline depleted cullet can be recycled as construction materials (e.g., concrete and brick manufacturing).

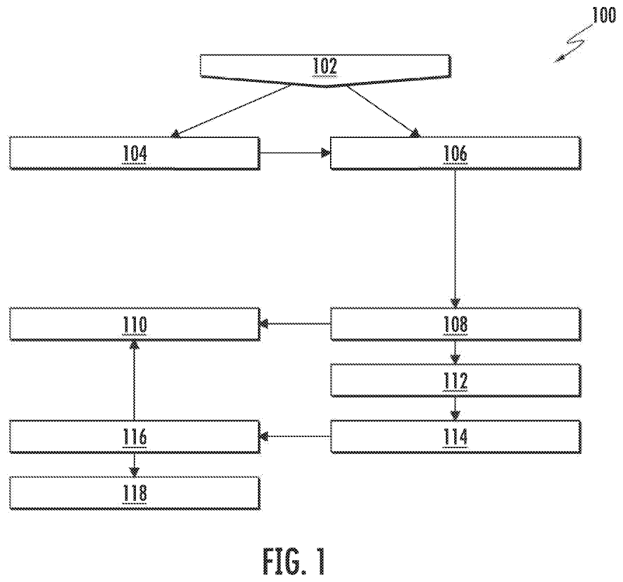

Referring now to FIG. 1, one embodiment of a process 100 disclosed herein for recovering lithium from lithium-containing glass-based materials may include providing lithium-containing particles 102; contacting 106 the lithium-containing particles with calcium salts in water at a first leaching temperature for a first leaching time to produce a first mixture; separating 108 the first mixture into a first leachate and a first residue; heat treating 112 the first residue to form a heat-treated residue; contacting 114 the heat-treated residue with water at a second leaching temperature for a second leaching time, wherein the contacting causes further leaching of lithium ions from the heat-treated residue into the liquid phase to produce a second mixture; separating 116 the second mixture into a second leachate and a second residue; and recovering 110 lithium from the first leachate, the second leachate, or both.

The lithium-containing particles may comprise lithium-containing glass-based materials, such as but not limited to lithium-containing glass, lithium-containing glass ceramics, or both. The lithium-containing particles may also be referred to herein as “waste glass-based materials.” The waste glass-based materials may be made from any glass-based composition or combinations of glass-based compositions comprising lithium, such as glass-based compositions comprising lithium oxide. In embodiments, the glass-based composition of the glass based materials may include at least silica (SiO₂), alumina (Al₂O₃), and lithium oxide (Li₂O). The glass-based compositions may also include boron trioxide (B₂O₃), zirconia (ZrO₂), alkali metal oxides (e.g., Na₂O, K₂O, etc), alkaline metal oxides (e.g., MgO, CaO, SrO, BaO), titanium dioxide (TiO₂), tin oxide (SnO₂), or combinations thereof. In embodiments, the glass-based compositions may include other constituents, such as but not limited to P₂O₅, Co₃O₄, Cr₂O₃, CuO, Fe₂O₃, NiO, Sb₂O₃, ZnO, HfO₂, or combinations thereof. By way of example and not limitation, in embodiments, the waste glass-based materials may comprise one or a plurality of different glass-based compositions, where the glass-based compositions may comprise from about 30 mol % to about 85 mol % SiO₂, from about 2 mol % to about 30 mol % Al₂O₃, from 0 mol % to about 20 mol % B₂O₃, from about 2 mol % to about 20 mol % Li₂O, from 0 mol % to about 20 mol % Na₂O, from 0 mol % to about 20 mol % K₂O, from 0 mol % to about 20 mol % MgO, from 0 mol % to about 20 mol % CaO, from 0 mol % to about 10 mol % SrO, from 0 mol % to about 10 mol % BaO, from 0 mol % to about 5 mol % ZrO₂, from 0 mol % to about 5 mol % TiO₂, and from 0 mol % to about 5 mol % SnO₂.

In embodiments, the lithium containing particles may comprise waste glass. In embodiments, the glass-based compositions of the waste glass may be characterized as having low chemical durability. Without being limited by theory, it is believed that water driven lithium extraction from glass may occur more quickly and completely when waste glass having low chemical durability is utilized. Low chemical durability glass-based compositions may be described by their alkaline chemical durability, their acid chemical durability, or both. Low chemical durability glass-based compositions may be defined as glass-based compositions with an alkaline chemical durability of greater than about 1.5 mg/cm² of weight loss when exposed to 5 wt. % NaOH at about 95° C. for a period of 24 hours, such as greater than about 1.75 mg/cm², greater than about 2 mg/cm², greater than about 2.1 mg/cm², or greater than about 2.2 mg/cm², based on the initial weight and surface area of the low durability glass-based composition. Low chemical durability glass-based compositions may be defined as glass-based compositions with an acid chemical durability of greater than 15 mg/cm² of weight loss when exposed to 5 wt. % HCl at about 95° C. for a period of 24 hours, such as greater than 17.5 mg/cm² or greater than 20 mg/cm², based on the initial weight and surface area of the low durability glass-based composition.

In embodiments, the glass-based compositions of the waste glass-based materials may comprise a low durability glass-based composition. In embodiments, the low durability glass-based compositions may have a concentration of magnesium (Mg), zirconium oxide (ZrO₂), or both that is less than or equal to about 8 mol %, such as less than or equal to about 7 mol. %, less than or equal to about 6 mol. %, less than or equal to about 5 mol. %, less than or equal to about 4 mol. %, less than or equal to about 3 mol. %, less than or equal to about 2 mol. %, or less than or equal to about 1 mol. %, based on the total moles of the glass-based composition. In embodiments, the low durability glass-based compositions may have a concentration of magnesium (Mg) that is less than or equal to about 8 mol %, such as less than or equal to about 7 mol. %, less than or equal to about 6 mol. %, less than or equal to about 5 mol. %, less than or equal to about 4 mol. %, less than or equal to about 3 mol. %, less than or equal to about 2 mol. %, or less than or equal to about 1 mol. %, based on the total moles of the glass-based composition. In embodiments, the low durability glass-based compositions may have a concentration of zirconium oxide (ZrO₂) that is less than or equal to about 0.20 mol %, such as less than or equal to about 0.16 mol. %, less than or equal to about 0.12 mol. %, less than or equal to about 0.08 mol. %, less than or equal to about 0.04 mol. %, less than or equal to about 0.02 mol. %, less than or equal to about 0.01 mol. %, or even less than or equal to about 0.001 mol. %, based on the total moles of the glass-based composition.

In embodiments, the waste glass-based materials may include waste glass having an amorphous structure. In embodiments, the waste glass with an amorphous structure may have less than about 5% crystallinity, such as less than about 4%, less than about 3%, less than about 2%, less than about 1%, or even less than about 0.1% crystallinity. Without being limited by theory, it is believed that glass-based materials with an amorphous crystal structure may be more susceptible to lithium removal by the water driven extraction methods disclosed herein compared to glass-based materials having a greater percent crystallinity, such as but not limited to glass-ceramics.

In embodiments, the lithium-containing particles are not heated to a temperature sufficient to cause a change in the phase assemblage of the glass-based composition. In embodiments, the temperature sufficient to cause a change in the phase assemblage of the glass-based composition may be at least about 800° C., such as about 900° C., about 1000° C., or about 1100° C.

In embodiments, the lithium containing particles may comprise waste glass-based materials that include lithium-containing glass ceramics. The lithium-containing glass ceramics may have the same general molar composition as the lithium-containing glass. However, the lithium-containing glass ceramics may have been formed in such a way as to create a specific crystal structure. In particular, glass ceramics may be produced by first producing a precursor glass having the compositions disclosed herein through conventional melting and glass forming procedures of glass manufacturing. After cool down, the precursor glass material may be subjected to a secondary heat treatment (i.e., ceramming process) that includes nucleation and crystal growth steps that are required to grow in the crystalline phases of interest to produce the glass ceramic. The crystal phase assemblage may be in part determined by the composition of the glass precursor as well as the conditions and process for ceramming the precursor glass to make the glass ceramic.

In embodiments, the lithium-containing glass ceramics contained in the waste glass-based materials may comprise a non-crystalline phase and a crystalline phase, wherein the crystalline phase may be selected from the group consisting of lithium silicate crystalline phase, lithium disilicate crystalline phase, the petalite crystalline phase, ß-spodumene, lithium metasilicate, virgilite, cristobalite, lithium phosphate, baddeleyite, zirconia, and any combinations thereof. In embodiments, the crystalline phase of the lithium-containing glass ceramics may be selected from the group consisting of the petalite crystalline phase, ß-spodumene, disilicate crystalline phase, and combinations thereof.

In embodiments, the lithium-containing glass ceramics contained in the waste glass-based materials may not have a ß-quartz solid solution phase, a lithium aluminum silicate phase, or a ketatite phase. In embodiments, the lithium-containing glass ceramics may have less than about 0.1 wt. %, or even less than about 0.01 wt. % of the combined weight of the ß-quartz solid solution phase, the lithium aluminum silicate phase, and the ketatite phase, based on the total weight of the lithium containing glass ceramics. Without being limited by theory, it is believed that the ß-quartz solid solution phase may have lower reactivity (higher chemical durability) than other phases due to its relatively small unit cell size. Accordingly, such ß-quartz solid solution phase crystals may require heat treatment to convert them to a different phase assemblage in order to extract lithium. In embodiments, the lithium-containing glass ceramics of the lithium containing particles may not have a zirconium titanate crystal phase assemblage. In embodiments, the lithium-containing glass ceramics may have less than about 0.1 wt. %, or even less than about 0.01 wt. % zirconium titanate crystal phase assemblage based on the total weight of the lithium-containing glass ceramics.

Referring again to FIG. 1, in embodiments, providing 102 the lithium-containing particles may comprise providing glass-based materials and crushing the glass-based materials produce the lithium-containing particles. In embodiments, the glass-based materials may already be in the form of particles, and providing 102 the lithium-containing particles may comprise reducing the size of the lithium-containing particles. Reducing the size of the lithium-containing particles may comprise crushing, grinding, or pulverizing the lithium-containing particles. The lithium-containing particles may be reduced in size as a byproduct of manufacturing processes such as cutting or grinding lithium-containing glass-based materials.

Prior to leaching, the lithium-containing particles may have an average particle size of from about 20 μm to about 1 mm, such as from about 20 μm to about 0.5 mm, from about 20 μm to about 0.3 μm, from about 20 μm to about 150 μm, from about 20 μm to about 125 μm, from about 20 μm to about 100 μm, from about 20 μm to about 75 μm, from about 20 μm to about 50 μm, from about 20 μm to about 30 μm, from about 30 μm to about 150 μm, from about 50 μm to about 150 μm, from about 75 μm to about 150 μm, from about 25 μm to about 125 μm, from about 50 μm to about 100 μm, or any subset thereof.

The lithium-containing particles may have a median particle size (d50) of from about 10 μm to about 1000 μm, such as from about 10 μm to about 750 μm, from about 10 μm to about 500 μm, from about 10 μm to about 250 μm, from about 10 μm to about 150 μm, from about 10 μm to about 100 μm, from about 10 μm to about 75 μm, from about 10 μm to about 50 μm, from about 10 μm to about 25 μm, from about 25 μm to about 1000 μm, from about 50 μm to about 1000 μm, from about 75 μm to about 1000 μm, from about 100 μm to about 1000 μm, from about 150 μm to about 1000 μm, from about 250 μm to about 1000 μm, from about 25 μm to about 750 μm, from about 50 μm to about 500 μm, from about 100 μm to about 250 μm, or any subset thereof. Without being limited by theory, it is believed that relatively smaller particle sizes may result in faster extraction times. However, it is believed that extremely small particle sizes, such as those with a d50 less than about 10 μm, may result in slower extraction times due to decreased percolation, caused by clumping, even in stirred reactors.

The process 100 for recovering lithium from the lithium-containing glass-based materials may further comprise heat treating 104 the lithium-containing particles. Heat treating 104 the lithium-containing particles may comprise exposing the lithium-containing particles to a temperature of from about 500° C. to about 700° C. prior to contacting the lithium-containing particles with the calcium salts and water. In embodiments, heat treating 104 the lithium-containing particles may be conducted at a temperature of from about 500° C. to about 650° C., from about 500° C. to about 600° C., from about 500° C. to about 550° C., from about 550° C. to about 700° C., from about 600° C. to about 700° C., or any subset thereof. In embodiments, heat treating 104 the lithium-containing particles may occur in the presence of air. Heat treating 104 the lithium-containing particles may serve to remove residual organic compounds, water, or both from the lithium-containing particles prior to extraction of lithium. Without being limited by theory, it is believed that heat treating 104 the lithium-containing particles at the temperatures disclosed above, such as those less than about 700° C. may effectively remove contaminants from the lithium-containing particles without causing a change in the crystal structure of the lithium-containing particles. In embodiments, the heat treating 104 the lithium-containing particles may not include heating the lithium-containing particles to temperatures at which the glass-based material undergoes changes in phase assemblage, such as temperatures greater than or equal to 700° C.

Referring again to FIG. 1, the process 100 may comprise contacting 106 the lithium-containing particles with calcium salts in water at a first leaching temperature for a first leaching time to produce a first mixture, wherein the contacting causes leaching of at least a portion of lithium ions from the lithium-containing particles into the liquid phase to produce the first mixture. The first mixture may comprise the first leachate, which includes the extracted lithium ions, and the first residue, which comprises residual solids having a reduced concentration of lithium compared to the lithium-containing particles.

Contacting 106 the lithium-containing particles with calcium salts in water may comprise adding the lithium-containing particles to a mixture of the calcium salts in water to produce a first extraction slurry. The extraction slurry may comprise calcium salts, water, and the lithium-containing particles. The calcium salts may comprise CaO, CaCl, Ca(OH)₂, CaCO₃, or combinations thereof. In embodiments, the calcium salts may comprise CaO. It is believed that the use of CaO may result in faster extraction times compared to other calcium salts.

A weight ratio of lithium-containing particles to calcium salts in the first extraction slurry may be from about 1:1 to about 1:8. In embodiments, the weight ratio of lithium-containing particles to calcium salts in the first mixture may be from about 1:1 to about 1:7, from about 1:1 to about 1:6, from about 1:1 to about 1:5, from about 1:1 to about 1:4, from about 1:1 to about 1:3, from about 1:2 to about 1:8, from about 1:3 to about 1:8, from about 1:4 to about 1:8, from about 1:2 to about 1:7, from about 1:3 to about 1:6, from about 1:3 to about 1:5, or any subset thereof. In embodiments, the weight ratio of lithium-containing particles to calcium salts in the first mixture may be about 1:4. Without being limited by theory, it is believed that increasing the amount of calcium salts, relative to the amount of lithium-containing particles, may increase the extraction rate of the lithium from the lithium-containing particles. This is believed to be driven by an increased chemical gradient. However, there is believed to be a threshold value, after which the kinetics can no longer drive increased extraction rates. This threshold value is believed to be about 1:8, however, the threshold value is also believed to be dependent upon characteristics of the lithium-containing particles, such as but not limited to composition, average particle size, crystal phases, or other characteristics of the lithium-containing particles.

In embodiments, a weight ratio of solids to liquids in the first extraction slurry may be from about 1:5 to about 1:15. In embodiments, the weight ratio of solids to liquids in the first extraction slurry may be from about 1:5 to about 1:14, from about 1:5 to about 1:13, from about 1:5 to about 1:12, from about 1:5 to about 1:11, from about 1:5 to about 1:10, from about 1:6 to about 1:15, from about 1:7 to about 1:15, from about 1:8 to about 1:15, from about 1:9 to about 1:15, from about 1:10 to about 1:15, from about 1:6 to about 1:14, from about 1:7 to about 1:13, from about 1:8 to about 1:12, from about 1:9 to about 1:11, or any subset thereof. In embodiments, the weight ratio of solids to liquids in the first extraction slurry may be about 1:10. It should be understood that solids in the first extraction slurry may include both the undissolved calcium salts and the lithium-containing particles. Without being limited by theory, it is believed that chemical kinetics may be controlled by the mixing rate. Decreasing the solids to liquids ratio is believed to increase the viscosity, which decreases the available stirring rate, which may decrease the extraction rate of lithium from the lithium-containing particles. In embodiments, the first extraction slurry may be stirred at a stirring rate of from 100 revolutions per minute (RPM) to 400 RPM.

A pH of the first extraction slurry may be less than about 12. In embodiments, the pH of the first extraction slurry may be from about 11 to about 12, from about 11 to about 11.5, from about 10 to about 12, from about 10 to about 11.5, from about 10.5 to about 11.5, or any subset thereof. The pH of the first extraction slurry may be achieved mostly or entirely through the addition of the calcium salts to the first extraction slurry. Accordingly, in embodiments, the first extraction slurry may comprise less than about 1 mol %, less than about 0.5 mol %, or even less than about 0.1 mol % of pH modification agents other than the calcium salt. In embodiments, the first extraction slurry may comprise less than about 1 mol %, less than about 0.5 mol %, or even less than about 0.1 mol % strong acids, strong bases, or both.

The first extraction slurry may be heated to a first leaching temperature and maintained at the first leaching temperature for a first leaching time to produce the first mixture comprising the first leachate and the first residue. The first leaching temperature may be sufficient to produce a commercially acceptable leaching rate of lithium from the lithium-containing particles. In embodiments, the first leaching temperature may be from about 80° C. to about 120° C., from about 80° C. to about 110° C., from about 80° C. to about 100° C., from about 80° C. to about 90° C., from about 90° C. to about 120° C., from about 90° C. to about 110° C., from about 90° C. to about 100° C., or about 100° C. This temperature near the boiling point of the first extraction slurry may be sustained through a condenser and refluxing system which may recycle the water vapor or by increasing the pressure of the reaction chamber. Contacting 106 the lithium-containing particles with calcium salts in water at the first leaching temperature for the first leaching time to produce a first mixture may further comprise condensing water vapor to produce condensed water and returning the condensed water back into contact with the lithium-containing particles and the calcium salts.

The first extraction slurry may be stirred or otherwise agitated while held at the first leaching temperature. The stirring or agitation rate may be sufficient to produce a commercially acceptable leaching rate of lithium from the lithium-containing particles. The first extraction slurry may be stirred or agitated by an impellor or with a magnetic stirrer. The impellor or magnetic stirrer may be rotated at from 100 RPM to 400 RPM.

In embodiments, contacting 106 the lithium-containing particles with calcium salts in water at the first leaching temperature for the first leaching time to produce a first mixture may be conducted at atmospheric pressure or at an elevated pressure greater than atmospheric pressure, such as a pressure of from about 2 pounds per square inch gauge pressure (psig) to about 32 psig (220 kpa), from about 4 psig (27.579 kpa) to about 32 psig (220 kpa), from about 6 psig (41.368 kpa) to about 32 psig (220 kpa), from about 8 psig (55.158 kpa) to about 32 psig (220 kpa), from about 12 psig (82.737 kpa) to about 32 psig (220 kpa), from about 2 psig (13.7895 kpa) to about 24 psig (165.474 kpa), from about 2 psig (13.7895 kpa) to about 18 psig (124.105 kpa), from about 2 psig (13.7895 kpa) to about 12 psig (82.737 kpa), from about 2 psig (13.7895 kpa) to about 8 psig (55.158 kpa), or any subset thereof. Contacting 106 the lithium-containing particles with calcium salts in water at the elevated pressure may result in reduced reaction times and more rapid extraction of the lithium from the lithium-containing particles. The contacting may occur in a pressure vessel, such as but not limited to an autoclave.

The first leaching time may be from about 1 hour (hr.) to about 12 hr. In embodiments, the first leaching time may be from about 1 hr. to about 8 hr., from about 1 hr. to about 4 hr., from about 2 hr. to about 12 hr., from about 2 hr. to about 8 hr., from about 2 hr. to about 4 hr., from about 4 hr. to about 12 hr., from about 4 hr. to about 8 hr., from about 6 hr. to about 12 hr., from about 8 hr. to about 12 hr., or any subset thereof.

In the first leaching step, contacting 106 the lithium-containing particles with water and calcium salts at the first leaching temperature for the first leaching time leaches at least a portion of the lithium ions from the lithium-containing particles into the first leachate. Leaching at least a portion of lithium ions from the lithium-containing particles in the first leaching step (e.g., contacting 106 in FIG. 1) may result in removing at least 20 wt. % of the lithium atoms from the lithium-containing particles, based on the total weight of lithium initially in the lithium-containing particles. In embodiments, leaching at least a portion of lithium ions from the lithium-containing particles may result in removing at least 30 wt. %, at least 35 wt. %, at least 40 wt. %, at least 45 wt. %, at least 50 wt. %, at least 55 wt. %, at least 60 wt. %, at least 65 wt. %, from about 30 wt. % to about 80 wt. %, from about 30 wt. % to about 70 wt. %, from about 40 wt. % to about 80 wt. %, from about 40 wt. % to about 70 wt. %, from about 50 wt. % to about 80 wt. %, from about 50 wt. % to about 70 wt. %, from about 60 wt. % to about 80 wt. %, from about 60 wt. % to about 70 wt. %, or any subset thereof, of the lithium atoms from the lithium-containing particles, based on the total weight of lithium initially in the lithium-containing particles.

Referring again to FIG. 1, following the first leaching step comprising the contacting 106, the process 100 may include separating 108 the first mixture into the first leachate and the first residue. Separating 108 the first mixture into the first leachate and the first residue may comprise any solid-liquid separation method capable of separating the solids of the first residue from the liquids of the first leachate. In embodiments, separating 108 the first mixture into the first leachate and the first residue may comprise centrifuging, filtering, vacuum filtering, settling and decantation, other solid-liquid separation process, or combinations thereof.

The first leachate may comprise a mixture of dissolved calcium and lithium ions in water. The first leachate may comprise other constituents of the lithium-containing particles leached into the liquid phase, such as but not limited to silica, aluminum, sodium, potassium, magnesium, or other constituents of the glass-based material. The first residue may comprise a mixture of reduced lithium particles and calcium salts, such as Ca(OH)₂. The reduced lithium particles in the first residue refers to the remaining portions of the lithium containing particles having a reduced concentration of lithium. The term “reduced lithium” particles refers to the concentration of lithium in the particles being reduced and does not imply any change in state of the remaining lithium (e.g., no implication of the lithium being chemically reduced). In embodiments, the reduced lithium particles in the first residue may comprise an amount of lithium that is less than or equal to 80%, less than or equal to 70%, less than or equal to 60%, less than or equal to 65%, less than or equal to 50%, less than or equal to 45%, less than or equal to 40%, or less than or equal to 35% of the amount of lithium in the lithium-containing particles prior to the contacting 108 with water and calcium ions in the first leaching step, where the percentage is based on the original amount of lithium and, therefore, is the same whether expressed on a weight or molar basis.

Referring again to FIG. 1, the processes 100 disclosed herein may include heat treating 112 the first residue to form a heat-treated residue after separating the first residue from the first mixture. The heat treating 112 the first residue to form a heat-treated residue may comprise exposing the first residue to heat treating conditions, such as a heat treatment temperature and heat treatment time, that are sufficient to convert Ca(OH)₂ back to CaO. In embodiments, the conditions sufficient to convert Ca(OH)₂ to CaO may include a heat treatment temperature of from about 400° C. to about 700° C., such as from about 450° C. to about 700° C., from about 500° C. to about 700° C., from about 550° C. to about 700° C., from about 600° C. to about 700° C., from about 400° C. to about 650° C., from about 450° C. to about 600° C., from about 450° C. to about 550° C., from about 500° C. to about 700° C., from about 500° C. to about 650° C., from about 500° C. to about 600° C., from about 550° C. to about 700° C., or any subset thereof. In embodiments, the heating treating conditions sufficient to convert Ca(OH)₂ to CaO may include a exposing the first residue to the heat treatment temperature for a heat treatment time of from about 2 hr. to about 12 hr., such as from about 2 hr. to about 10 hr., from about 2 hr. to about 8 hr., from about 2 hr. to about 6 hr., from about 2 hr. to about 4 hr., from about 4 hr. to about 12 hr., from about 6 hr. to about 12 hr., from about 8 hr. to about 12 hr., from about 10 hr. to about 12 hr., from about 4 hr. to about 10 hr., from about 6 hr. to about 8 hr., or any subset thereof. Exposing the first residue to heat treating conditions sufficient to convert Ca(OH)₂ to CaO may comprise exposing the first residue to the heat treatment temperature in the presence of oxygen, which may be provided by air or other oxygen-containing gas. In embodiments, the first residue may be exposed to the heat treating temperature in a furnace, such as a muffle furnace. The heat-treated residue may comprise the reduced lithium particles and CaO.

Referring again to FIG. 1, the process 100 may further comprise contacting 114 the heat-treated residue with water at a second leaching temperature for a second leaching time after the heat treating. Contacting the heat-treated residue with water may comprise a second leaching step. The contacting 114 in the second leaching step may cause further leaching of lithium ions from the reduced lithium particles of the heat-treated residue into the liquid phase to produce a second mixture. Contacting 114 the heat-treated residue with water in the second leaching step may comprise combining the heat-treated residue with water to produce a second leaching slurry. The second leaching slurry may comprise calcium salts, water, and the reduced lithium particles. The calcium salts may comprise CaO, CaCl, Ca(OH)₂, CaCO₃, or combinations thereof. In embodiments, the calcium salts may comprise CaO. In embodiments, all of the calcium atoms present in the second leaching slurry may have been present in the first mixture produced from the first leaching step. In embodiments, the contacting 114 may comprise adding additional calcium salts to the second leaching slurry.

A weight ratio of the reduced lithium particles to calcium salts in the second leaching slurry may be from about 1:1 to about 1:8. In embodiments, the weight ratio of reduced lithium particles to calcium salts in the second leaching slurry may be from about 1:1 to about 1:7, from about 1:1 to about 1:6, from about 1:1 to about 1:5, from about 1:1 to about 1:4, from about 1:1 to about 1:3, from about 1:2 to about 1:8, from about 1:3 to about 1:8, from about 1:4 to about 1:8, from about 1:2 to about 1:7, from about 1:3 to about 1:6, or any subset thereof. In embodiments, the weight ratio of the reduced lithium particles to calcium salts in the second leaching slurry may be about 1:4.

A weight ratio of solids to liquids in the second leaching slurry may be from about 1:5 to about 1:15. In embodiments, the weight ratio of solids to liquids in the second leaching slurry may be from about 1:5 to about 1:14, from about 1:5 to about 1:13, from about 1:5 to about 1:12, from about 1:5 to about 1:11, from about 1:5 to about 1:10, from about 1:6 to about 1:15, from about 1:7 to about 1:15, from about 1:8 to about 1:15, from about 1:9 to about 1:15, from about 1:10 to about 1:15, from about 1:6 to about 1:14, from about 1:7 to about 1:13, from about 1:8 to about 1:12, from about 1:9 to about 1:11, or any subset thereof. In embodiments, the weight ratio of solids to liquids in the second leaching slurry may be about 1:10. A pH of the second leaching slurry may be less than 12. In embodiments, the pH of the second leaching may be from about 11 to about 12, from about 11 to about 11.5, from about 10 to about 12, from about 10 to about 11.5, from about 10.5 to about 11.5, or any subset thereof.

The second leaching slurry may be stirred during the second leaching step (e.g., the contacting 114). The second leaching temperature may be sufficient to leach lithium from the reduced lithium particles at a commercially acceptable leaching rate. In embodiments, the second leaching temperature may be from about 80° C. to about 120° C., from about 80° C. to about 110° C., from about 80° C. to about 100° C., from about 80° C. to about 90° C., from about 90° C. to about 120° C., from about 90° C. to about 110° C., from about 90° C. to about 100° C., or about 100° C. Contacting 114 the reduced lithium particles with calcium salts in water at a second leaching temperature for a second leaching time to produce a second mixture may further comprise condensing water vapor to produce condensed water and returning the condensed water back into contact with the reduced lithium particles and the calcium salts.

In embodiments, the second extraction slurry may be stirred or otherwise agitated while held at the second leaching temperature. The stirring or agitation rate may be sufficient to produce a commercially acceptable leaching rate of lithium from the reduced lithium particles. The second extraction slurry may be stirred or agitated by an impellor or with a magnetic stirrer. The impellor or magnetic stirrer may be rotated at from 100 RPM to 400 RPM.

In embodiments, contacting 114 the reduced lithium particles with the calcium salts and water at the second leaching temperature for the second leaching time to produce the second mixture may occur at an elevated pressure, such as a pressure of from 2 psig (13.785 kpa) to 32 psig (220 kpa), from 4 psig (27.579 kpa) to 32 psig (220 kpa), from 6 psig (41.368 kpa) to 32 psig (220 kpa), from 8 psig (55.158 kpa) to 32 psig (220 kpa), from 12 psig (82.737 kpa) to 32 psig (220 kpa), from 2 psig (13.7895 kpa) to 24 psig (165.474 kpa), from 2 psig (13.7895 kpa) to 18 psig (124.105 kpa), from 2 psig (13.7895 kpa) to 12 psig (82.737 kpa), from 2 psig (13.7895 kpa) to 8 psig (55.158 kpa), or any subset thereof. Contacting 114 the reduced lithium particles with the calcium salts and water at the second leaching temperature at an elevated pressure greater than atmospheric pressure may result in reduced reaction times and increasing leaching rate. When conducted at an elevated pressure above atmospheric pressure, the contacting 114 may be conducted in a pressure vessel, such as an autoclave.

The second leaching time may be from about 1 hr. to about 12 hr. In embodiments, the second leaching time may be from about 1 hr. to about 8 hr., from about 1 hr. to about 4 hr., from about 2 hr. to about 12 hr., from about 2 hr. to about 8 hr., from about 2 hr. to about 4 hr., from about 4 hr. to about 12 hr., from about 4 hr. to about 8 hr., from about 6 hr. to about 12 hr., from about 8 hr. to about 12 hr., or any subset thereof.

Leaching of lithium ions from the reduced lithium particles in the second leaching step (e.g., contacting 114) may result in removing at least 20 wt. % of the lithium atoms from the reduced lithium particles, based on the total weight of lithium initially in the reduced lithium particles after their removal from the first mixture and before the second leaching. In embodiments, leaching at least a portion of lithium ions from the reduced lithium particles may result in removing at least 30 wt. %, at least 35 wt. %, at least 40 wt. %, at least 45 wt. %, at least 50 wt. %, at least 55 wt. %, at least 60 wt. %, at least 65 wt. %, or any subset thereof, of the lithium atoms from the reduced lithium particles, based on the total weight of lithium initially in the reduced lithium particles after their removal from the first mixture and prior to the second leaching step.

Referring again to FIG. 1, following the contacting 114 of the second leaching step to produce the second mixture, the processes 100 may include separating 116 the second mixture into a second leachate and a second residue. Separating 116 the second mixture into the second leachate and the second residue may comprise any separation method. In embodiments, separating 116 the second mixture into the second leachate and the second residue may comprise centrifuging, filtering, vacuum filtering, settling and decantation, other solid-liquid separation process, or combinations thereof.

The second leachate may comprise a mixture of dissolved calcium ions and lithium ions. In embodiments, the second leachate may comprise other species leached from the reduced lithium particles in the second leaching step.

The second residue may comprise a mixture of lithium-depleted particles and calcium salts, such as Ca(OH)₂. The lithium-depleted particles in the second residue may now be depleted of lithium. In embodiments, the lithium-depleted particles in the second residue may comprise an amount of lithium that is less than or equal to about 50 wt. %, less than or equal to about 40 wt. %, less than or equal to about 30 wt. %, less than or equal to about 20 wt. %, less than or equal to about 15 wt. %, less than or equal to about 10 wt. %, less than or equal to about 5 wt. %, or even less than or equal to about 1 wt. % of the amount of lithium in the lithium-containing particles before the first leaching step (e.g., before contacting 106).

The process 100 may comprise recovering 110 lithium from the first leachate, the second leachate, or both. Recovering 110 lithium from the first leachate, the second leachate, or both may comprise precipitating lithium salts from the first leachate, the second leachate, or both. Precipitating lithium salts out of the first leachate, the second leachate, or both may comprise adding a precipitating agent to the first leachate, the second leachate, or both. The precipitating agent may comprise carbonate salts, phosphate salts, or both. In embodiments, the precipitating agent may comprise sodium carbonate, sodium phosphate, or both. These precipitating agents may bind to the lithium ions in solution and form lithium salts, such as lithium carbonate, lithium sodium phosphate, lithium phosphate, or combinations thereof. The solubilities of the lithium carbonate, lithium sodium phosphate, lithium phosphate, or combinations thereof in water may be low enough so that the lithium carbonate, lithium sodium phosphate, lithium phosphate, or combinations thereof precipitate from the solution. In embodiments, sodium carbonate may be used as the precipitating agent and the process of recovering 110 the lithium salts may include concentrating the first leachate, second leachate, or both by evaporating water from the first leachate, the second leachate, or both prior to adding the precipitating agent. The lithium salts may then be separated from the liquid of the first leachate, the second leachate, or both through any suitable solid-liquid separation process.

The process 100 may have an extraction efficiency of from about 60% to about 100%, from about 70% to about 100%, from about 80% to about 100%, from about 90% to about 100%, from about 95% to about 100%, from about 99% to about 100%, or any subset thereof. The extraction efficiency may be defined as the [(Li content in of the lithium containing particles)−(Li content in the Li depleted particles)]/[Li content in the lithium containing particles]. At least 60%, at least 65%, at least 70%, at least 75%, at least 80%, at least 90%, at least 95%, or even at least 99% of the lithium initially in the lithium-containing particles may be recovered from the first leachate, the second leachate, or from the combination of the first leachate and the second leachate.

In embodiments, the recovered lithium salts may be of high purity. In embodiments, the recovered lithium, such as lithium salts, may have less than 5 wt. %, such as from about 0 wt. % to about 2 wt. %, from about 0 wt. % to about 1 wt. %, or even from about 0 wt. % to about 0.1 wt. % of metals other than lithium based on the total weight of the lithium salts recovered from the process 100. The metals other than lithium may include alkali metals other than lithium, alkaline earth metals, transition metals, or combinations thereof. The recovered lithium, such as lithium salts, (e.g., lithium carbonate, lithium phosphate, lithium sodium phosphate, etc.) may be used as a lithium precursor to make lithium-containing glass-based materials. In embodiments, the recovered lithium salts may be used as a lithium precursor for the production of batteries.

The lithium depleted particles in the second residue may comprise the constituents of the glass-based materials remaining in the particles and not extracted during the process 100. The lithium depleted particles may comprise less than about 20%, less than about 10%, less than 5%, less than 2.5%, or even less than 1% of the lithium originally present in the lithium-containing particles prior to the process 100, where the percentages are based on the moles of lithium, though in this case the percentages are the same whether expressed on a molar basis or a weight basis. In embodiments, the lithium depleted particles may comprise from 0% to about 20%, from 0% to about 10%, from 0% to about 5%, from 0% to about 1%, from about 0.1% to about 20%, from about 0.1% to about 10%, or from about 0.1% to about 5%, from about 0.1% to 1% of the lithium originally present in the lithium-containing particles prior to the process 100. In embodiments, the lithium depleted particles may have less than about 4 mol % lithium, less than about 2 mol % lithium, less than about 1 mol % lithium, less than about 0.5 mol % lithium, less than about 0.2 mol % lithium, or even less than about 0.1 mol % lithium. In embodiments, the lithium depleted particles in the second residue may have from 0 mol % to about 4 mol %, from 0 mol % to about 2 mol %, from 0 mol % to about 1 mol %, from 0 mol % to about 0.5 mol %, from 0 mol % to about 0.2 mol %, from 0 mol % to about 0.1 mol %, from about 0.0001 mol % to about 4 mol %, from about 0.0001 mol % to about 2 mol %, from about 0.0001 mol % to about 1 mol %, from about 0.0001 mol % to about 0.5 mol %, from about 0.0001 mol % to about 0.2 mol %, or from about 0.0001 mol % to about 0.1 mol % lithium based on the total moles of constituents in the lithium depleted particles, where the mol % in the lithium depleted particles is determined after removing any of the residual second leachate and calcium salts from the surfaces of the lithium depleted particles. The lithium depleted particles may comprise greater than 98%, greater than 99%, or even greater than 99.5% of the silica originally present in the lithium containing particles prior to the process 100, on a mole basis.

The process 100 may comprise disposing 118 of the lithium depleted particles. In embodiments, disposing 118 of the lithium depleted particles may comprise recycling the lithium depleted particles back to a production process for producing glass-based materials or for cement manufacturing. In embodiments, if the lithium content of the lithium depleted particles is low enough and the composition of the lithium depleted particles is consistent and stable, the lithium depleted particles may be added back to a glass or glass-ceramic production process for making low lithium content glass-based materials. In embodiments, the lithium depleted particles may be recycled to a cement manufacturing process for making cement precursors or cement slurries.

Referring again to the composition of the lithium containing particles, SiO₂, an oxide involved in the formation of glass-based compositions, can function to stabilize the networking structure of glass-based compositions. The amount of SiO₂ may be limited to control the melting temperature of the glass-based compositions, since the melting temperatures of pure SiO₂ and glasses with high-SiO₂ concentration are high. In embodiments, the glass-based compositions of the waste glass-based materials may comprise from about 30 mol % to about 85 mol % SiO₂, based on the total moles of the glass-based composition. In embodiments, the glass-based compositions of the waste glass-based materials may comprise from about 30 mol % to about 85 mol %, about 30 mol % to about 75 mol %, about 30 mol % to about 70 mol %, about 40 mol % to about 85 mol %, about 40 mol % to about 80 mol %, about 40 mol % to about 75 mol %, about 40 mol % to about 70 mol %, about 50 mol % to about 85 mol %, about 50 mol % to about 80 mol %, about 50 mol % to about 75 mol %, about 50 mol % to about 70 mol %, about 60 mol % to about 85 mol %, about 60 mol % to about 80 mol %, about 60 mol % to about 75 mol %, or about 60 mol % to 70 mol % SiO₂ based on the total moles of the glass-based composition.

The glass-based composition of the waste glass-based materials may also include Al₂O₃, which may be included to provide stabilization to the glass network and also to provide improved mechanical properties and chemical durability to the glass-based compositions. In embodiments, the glass-based compositions of the waste glass-based materials may comprise from about 2 mol % to about 30 mol % Al₂O₃, based on the total moles of the glass-based compositions. In embodiments, glass-based compositions of the waste glass-based materials may comprise from about 2 mol % to about 25 mol %, from about 2 mol % to about 20 mol %, from about 2 mol % to about 10 mol %, from about 2 mol % to about 5 mol %, from about 5 mol % to about 30 mol %, from about 5 mol % to about 25 mol %, from about 5 mol % to about 20 mol %, from about 5 mol % to about 10 mol %, from about 10 mol % to about 30 mol %, from about 10 mol % to about 25 mol %, from about 10 mol % to about 20 mol %, or from about 20 mol % to about 30 mol % Al₂O₃, based on the total moles of the glass-based compositions.

In embodiments, the glass-based compositions of the waste glass-based materials may comprise lithium oxide. The glass-based compositions of the waste glass-based materials may comprise from about 2 to about 20 mol % Li₂O, based on the total moles of the glass-based compositions. In embodiments, the glass-based compositions of the waste glass-based materials may comprise from about 2 mol % to about 15 mol %, from about 2 mol % to about 10 mol %, from about 2 mol % to about 5 mol %, from about 5 mol % to about 20 mol %, from about 5 mol % to about 15 mol %, from about 5 mol % to about 10 mol %, from about 10 mol % to about 20 mol %, or from about 10 mol % to about 15 mol % Li₂O, based on the total moles of the glass-based compositions.

In embodiments, the glass-based compositions of the waste glass-based materials can include boron. In embodiments, the glass-based compositions of the waste glass-based materials can include boron trioxide (B₂O₃). B₂O₃ may reduce a melt temperature of the glass-based compositions and/or viscosity of the glass-based compositions. In embodiments, the glass-based compositions of the waste glass-based materials include may include from 0 mol % to about 20 mol % B₂O₃ based on the total moles of the glass-based compositions. In embodiments, the glass-based compositions of the waste glass-based materials may include from 0 mol % to about 15 mol %, from 0 mol % to about 10 mol %, from 0 mol % to about 5 mol %, from 0 mol % to about 2 mol %, from about 2 mol % to about 20 mol %, from about 2 mol % to about 15 mol %, from about 2 mol % to about 10 mol %, from about 2 mol % to about 5 mol %, from about 5 mol % to about 20 mol %, from about 5 mol % to about 15 mol %, from about 5 mol % to about 10 mol %, from about 10 mol % to about 20 mol %, or from about 10 mol % to about 15 mol % B₂O₃ based on the total moles of the glass-based compositions.

In embodiments, the glass-based compositions of the waste glass-based materials can include non-lithium alkali metal oxides, such as Na₂O, K₂O, or both. Na₂O and K₂O are well-known in glass chemistry as “fluxes”, which refer to constituents that reduce the viscosity of glass and may be present in many types of glass-based compositions. In contrast, alumina (Al₂O₃) and zirconia (ZrO₂) tend to increase the viscosity of glass-based compositions. In embodiments, the glass-based compositions of the waste glass-based materials may comprise from 0 mol % to about 40 mol %, from 0 mol % to about 30 mol %, from 0 mol % to about 25 mol %, from 0 mol % to about 20 mol %, from about 0 mol % to about 10 mol %, from about 1 mol % to about 40 mol %, from about 1 mol % to about 30 mol %, from about 1 mol % to about 25 mol %, from about 1 mol % to about 20 mol %, from about 1 mol % to about 10 mol %, from about 5 mol % to about 40 mol %, from about 5 mol % to about 30 mol %, from about 5 mol % to about 25 mol %, from about 5 mol % to about 20 mol %, from about 5 mol % to about 15 mol %, from about 5 mol % to about 10 mol %, or from about 0 mol % to 0.001 mol % non-lithium alkali metal oxides, based on the total moles of the glass-based compositions, where the non-lithium alkali metal oxides comprise Na₂O, K₂O, or both.

In embodiments, the glass-based compositions of the waste glass-based materials may comprise Na₂O. In embodiments, the glass-based compositions of the waste glass-based materials may comprise from 0 mol % to about 20 mol % Na₂O based on the total moles of the glass-based compositions. In embodiments, the glass-based compositions of the waste glass-based materials may comprise from 0 mol % to about 15 mol %, from 0 mol % to about 10 mol %, from 0 mol % to about 5 mol %, from about 1 mol % to about 20 mol %, from about 1 mol % to about 15 mol %, from about 1 mol % to about 10 mol %, from about 1 mol % to about 5 mol %, from about 5 mol % to about 20 mol %, from about 5 mol % to about 15 mol %, from about 5 mol % to about 10 mol %, or from about 10 mol % to about 20 mol % Na₂O, based on the total moles of the glass-based compositions.

In embodiments, the glass-based compositions of the waste glass-based materials may comprise K₂O. In embodiments, the glass-based compositions of the waste glass-based materials may comprise from 0 mol % to about 20 mol % K₂O based on the total moles of the glass-based compositions. In embodiments, the glass-based compositions may comprise from 0 mol % to about 15 mol %, from 0 mol % to about 10 mol %, from 0 mol % to about 5 mol %, from about 1 mol % to about 20 mol %, from about 1 mol % to about 15 mol %, from about 1 mol % to about 10 mol %, from about 1 mol % to about 5 mol %, from about 5 mol % to about 20 mol %, from about 5 mol % to about 15 mol %, from about 5 mol % to about 10 mol %, or from about 10 mol % to about 20 mol % K₂O, based on the total moles of the glass-based compositions in the waste glass-based materials.

In addition to non-lithium alkali metal oxides, alkaline earth metal oxides may also be present in the glass-based compositions of the waste glass-based materials. Alkaline earth metal oxides can include CaO, MgO, SrO, BaO, or combinations thereof. In embodiments, the glass-based compositions of the waste glass-based materials may have from 0 mol % (zero mol %) to about 30 mol % total RO based on the total moles of the glass-based compositions, where RO comprises CaO, MgO, SrO, BaO, or combinations thereof. In embodiments, the glass-based compositions of the waste glass-based materials may comprise from 0 mol % to about 25 mol %, from 0 mol % to about 20 mol %, from 0 mol % to about 15 mol %, from 0 mol % to about 10 mol %, from about 0.5 mol % to about 30 mol %, from about 0.5 mol % to about 25 mol %, from about 0.5 mol % to about 20 mol %, from about 0.5 mol % to about 15 mol %, from about 0.5 mol % to about 10 mol %, from 0.5 mol % to about 5 mol %, from about 5 mol % to about 30 mol %, from about 5 mol % to about 25 mol %, from about 5 mol % to about 20 mol %, from about 5 mol % to about 10 mol %, from about 10 mol % to about 30 mol %, from about 10 mol % to about 25 mol %, or from about 10 mol % to about 20 mol % total RO, based on the total moles of the glass-based compositions.

In embodiments, the glass-based compositions of the waste glass-based materials may comprise MgO. In embodiments, the glass-based compositions may comprise from 0 mol % to about 20 mol %, from 0 mol % to about 15 mol %, from 0 mol % to about 10 mol %, from 0 mol % to about 5 mol %, from about 0.1 mol % to about 20 mol %, from about 0.1 mol % to about 15 mol %, from about 0.1 mol % to about 10 mol %, from about 0.1 mol % to about 5 mol %, from about 1 mol % to about 20 mol %, from about 1 mol % to about 15 mol %, from about 1 mol % to about 10 mol %, from about 1 mol % to about 5 mol %, from about 5 mol % to about 20 mol %, from about 5 mol % to about 15 mol %, from about 5 mol % to about 10 mol %, or from about 10 mol % to about 20 mol % MgO, based on the total moles of the glass-based compositions.

In embodiments, the glass-based compositions of the waste glass-based materials may comprise CaO. In embodiments, the glass-based compositions may comprise from 0 mol % to about 20 mol %, from 0 mol % to about 15 mol %, from 0 mol % to about 10 mol %, from 0 mol % to about 5 mol %, from about 0.1 mol % to about 20 mol %, from about 0.1 mol % to about 15 mol %, from about 0.1 mol % to about 10 mol %, from about 0.1 mol % to about 5 mol %, from about 1 mol % to about 20 mol %, from about 1 mol % to about 15 mol %, from about 1 mol % to about 10 mol %, from about 1 mol % to about 5 mol %, from about 5 mol % to about 20 mol %, from about 5 mol % to about 15 mol %, from about 5 mol % to about 10 mol %, or from about 10 mol % to about 20 mol % CaO, based on the total moles of the glass-based compositions.

In embodiments, the glass-based compositions of the waste glass-based materials may comprise SrO. In embodiments, the glass-based compositions may comprise from 0 mol % to about 10 mol %, from 0 mol % to about 8 mol %, from 0 mol % to about 5 mol %, from 0 mol % to about 2 mol %, from about 0.1 mol % to about 10 mol %, from about 0.1 mol % to about 8 mol %, from about 0.1 mol % to about 5 mol %, from about 0.1 mol % to about 2 mol %, from about 1 mol % to about 10 mol %, from about 1 mol % to about 8 mol %, from about 1 mol % to about 5 mol %, from about 2 mol % to about 10 mol %, from about 2 mol % to about 8 mol %, from about 2 mol % to about 5 mol %, or from about 5 mol % to about 10 mol % SrO, based on the total moles of the glass-based compositions.

In embodiments, the glass-based compositions of the waste glass-based materials may comprise BaO. In embodiments, the glass-based compositions may comprise from 0 mol % to about 10 mol %, from 0 mol % to about 8 mol %, from 0 mol % to about 5 mol %, from 0 mol % to about 2 mol %, from about 0.1 mol % to about 10 mol %, from about 0.1 mol % to about 8 mol %, from about 0.1 mol % to about 5 mol %, from about 0.1 mol % to about 2 mol %, from about 1 mol % to about 10 mol %, from about 1 mol % to about 8 mol %, from about 1 mol % to about 5 mol %, from about 2 mol % to about 10 mol %, from about 2 mol % to about 8 mol %, from about 2 mol % to about 5 mol %, or from about 5 mol % to about 10 mol % BaO, based on the total moles of the glass-based compositions

In glass-based compositions, it is generally found that ZrO₂ can improve the stability of Li₂O—Al₂O₃—SiO₂ glass by significantly reducing glass devitrification during forming and lowering the liquid's temperature. At concentrations above 8 wt. %, ZrSiO₄ can form a primary liquid phase at a high temperature, which significantly lowers the liquid's viscosity. Transparent glasses can be formed when the glass-based composition contains over 2 wt. % ZrO₂. In embodiments, the glass-based compositions of the waste glass-based materials may comprise from 0 mol % to about 5 mol %, from 0 mol % to about 3 mol %, from 0 mol % to about 2 mol %, from about 0.1 mol % to about 5 mol %, from about 0.1 mol % to about 3 mol %, from about 0.1 mol % to about 2 mol %, from about 1 mol % to about 5 mol %, from about 1 mol % to 3 mol %, from about 1 mol % to about 2 mol %, from about 2 mol % to about 5 mol %, from about 2 mol % to about 3 mol %, or from about 3 mol % to about 5 mol % ZrO₂, based on the total moles of the glass-based compositions.

In embodiments, the glass-based compositions of the waste glass-based materials may include one or more other glass constituents, such as but not limited to of Fe₂O₃, SnO₂, HfO₂, TiO₂, P₂O₅, CO₃O₄, Cr₂O₃, CuO, ZnO, NiO, Sb₂O₃, or combinations thereof. In embodiments, the glass-based compositions of the waste glass-based materials may include TiO₂. In embodiments, the glass-based compositions of the waste glass-based materials may comprise from 0 mol % to about 5 mol %, from 0 mol % to about 3 mol %, from 0 mol % to about 2 mol %, from about 0.1 mol % to about 5 mol %, from about 0.1 mol % to about 3 mol %, from about 0.1 mol % to about 2 mol %, from about 1 mol % to about 5 mol %, from about 1 mol % to 3 mol %, from about 1 mol % to about 2 mol %, from about 2 mol % to about 5 mol %, from about 2 mol % to about 3 mol %, or from about 3 mol % to about 5 mol % TiO₂ based on the total moles of the glass-based compositions. In embodiments, the glass-based compositions of the waste glass-based materials may include SnO₂. In embodiments, the glass-based compositions of the waste glass-based materials may comprise from 0 mol % to about 5 mol %, from 0 mol % to about 3 mol %, from 0 mol % to about 2 mol %, from about 0.1 mol % to about 5 mol %, from about 0.1 mol % to about 3 mol %, from about 0.1 mol % to about 2 mol %, from about 1 mol % to about 5 mol %, from about 1 mol % to 3 mol %, from about 1 mol % to about 2 mol %, from about 2 mol % to about 5 mol %, from about 2 mol % to about 3 mol %, or from about 3 mol % to about 5 mol % SnO₂ based on the total moles of the glass-based compositions. In embodiments, the glass-based compositions of the waste glass-based materials may comprise from 0 mol % to about 5 mol %, from 0 mol % to about 3 mol %, from 0 mol % to about 2 mol %, from about 0.1 mol % to about 5 mol %, from about 0.1 mol % to about 3 mol %, from about 0.1 mol % to about 2 mol %, from about 1 mol % to about 5 mol %, from about 1 mol % to 3 mol %, from about 1 mol % to about 2 mol %, from about 2 mol % to about 5 mol %, from about 2 mol % to about 3 mol %, or from about 3 mol % to about 5 mol % P₂O₅ based on the total moles of the glass-based compositions. In embodiments, the glass-based compositions of the waste glass-based materials may comprise from 0 mol % to about 5 mol %, from 0 mol % to about 3 mol %, from 0 mol % to about 2 mol %, from about 0.1 mol % to about 5 mol %, from about 0.1 mol % to about 3 mol %, from about 0.1 mol % to about 2 mol %, from about 1 mol % to about 5 mol %, from about 1 mol % to 3 mol %, from about 1 mol % to about 2 mol %, from about 2 mol % to about 5 mol %, from about 2 mol % to about 3 mol %, or from about 3 mol % to about 5 mol % Co₃O₄ based on the total moles of the glass-based compositions. In embodiments, the glass-based compositions of the waste glass-based materials may comprise from 0 mol % to about 5 mol %, from 0 mol % to about 3 mol %, from 0 mol % to about 2 mol %, from about 0.1 mol % to about 5 mol %, from about 0.1 mol % to about 3 mol %, from about 0.1 mol % to about 2 mol %, from about 1 mol % to about 5 mol %, from about 1 mol % to 3 mol %, from about 1 mol % to about 2 mol %, from about 2 mol % to about 5 mol %, from about 2 mol % to about 3 mol %, or from about 3 mol % to about 5 mol % CuO based on the total moles of the glass-based compositions. In embodiments, the glass-based compositions of the waste glass-based materials may comprise from 0 mol % to about 5 mol %, from 0 mol % to about 3 mol %, from 0 mol % to about 2 mol %, from about 0.1 mol % to about 5 mol %, from about 0.1 mol % to about 3 mol %, from about 0.1 mol % to about 2 mol %, from about 1 mol % to about 5 mol %, from about 1 mol % to 3 mol %, from about 1 mol % to about 2 mol %, from about 2 mol % to about 5 mol %, from about 2 mol % to about 3 mol %, or from about 3 mol % to about 5 mol % ZnO based on the total moles of the glass-based compositions. In embodiments, the glass-based compositions of the waste glass-based materials may comprise from 0 mol % to about 5 mol %, from 0 mol % to about 3 mol %, from 0 mol % to about 2 mol %, from about 0.1 mol % to about 5 mol %, from about 0.1 mol % to about 3 mol %, from about 0.1 mol % to about 2 mol %, from about 1 mol % to about 5 mol %, from about 1 mol % to 3 mol %, from about 1 mol % to about 2 mol %, from about 2 mol % to about 5 mol %, from about 2 mol % to about 3 mol %, or from about 3 mol % to about 5 mol % NiO based on the total moles of the glass-based compositions. In embodiments, the glass-based compositions of the waste glass-based materials may comprise from 0 mol % to about 5 mol %, from 0 mol % to about 3 mol %, from 0 mol % to about 2 mol %, from about 0.1 mol % to about 5 mol %, from about 0.1 mol % to about 3 mol %, from about 0.1 mol % to about 2 mol %, from about 1 mol % to about 5 mol %, from about 1 mol % to 3 mol %, from about 1 mol % to about 2 mol %, from about 2 mol % to about 5 mol %, from about 2 mol % to about 3 mol %, or from about 3 mol % to about 5 mol % Sb₂O₃ based on the total moles of the glass-based compositions.

### EXAMPLES

The embodiments of the methods of the present disclosure for recovering lithium from waste glass-based materials will be further clarified by the following examples.

### Example 1

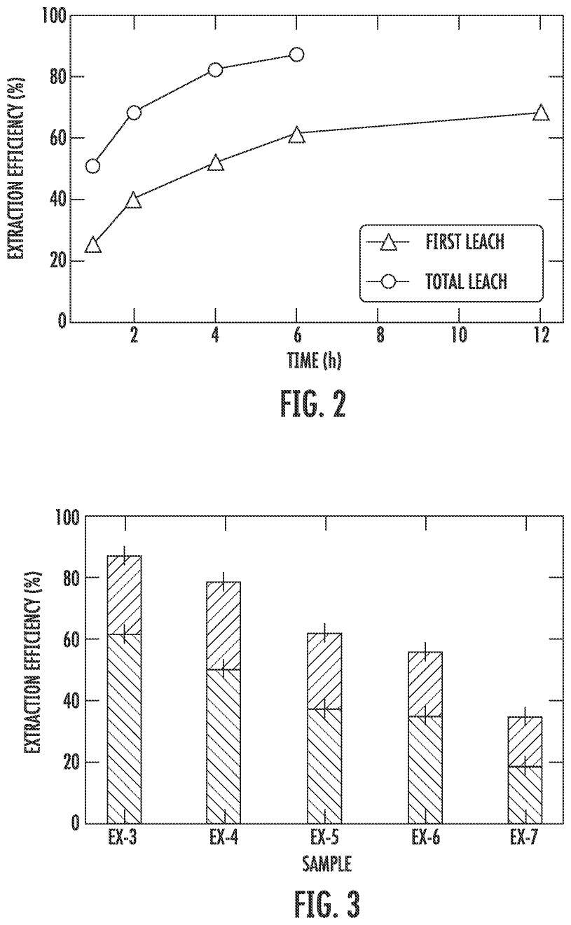

In Example 1, waste glass-based materials comprising a waste glass having the general composition of Example 3 in Table 2 was crushed to produce lithium-containing particles having a d10 of 1.9 μm, a d50 of 12 μm, and a d90 of 33 μm. the lithium-containing particles were then heat-treated at 500° C. for 4 hours. Then, 12 g of the heat-treated glass fines were mixed with 48 g of CaO powder and added to 600 ml of water. The weight ratio of lithium-containing particles to CaO was 1:4, and the solid to liquid volume ratio was 1:10. The reaction was conducted at 100° C. under atmospheric pressure with a stir rate of 300 RPM for 1 hr. The process was then repeated with leaching times of 2 hr., 4 hr., 6 hr., and 12 hr. Results are shown in FIG. 2 and Table 1 below.

### Example 2

In Example 2, the residual solids from each extraction of Example 1 were heat-treated at 500° C. for 4 hours. Then, about 50 g of the heat-treated residual solids were mixed with 500 ml of water. The weight ratio of lithium-containing particles to CaO was 1:4 and the solid to liquid volume ratio was 1:10. The reaction was conducted at 100° C. with a stir rate of 300 RPM. The 1 hr. extraction from Example 1 was reacted for a further 1 hr., to achieve a total reaction time of 2 hr. The 2 hr. extraction from Example 1 was reacted for a further 2 hr., to achieve a total reaction time of 4 hr., and so forth. However, the 12 hr. extraction was not repeated. Results are shown in FIG. 2 and Table 1.

TABLE 1

| | 1 hr. | 2 hr. | 4 hr. | 6 hr. | 12 hr. |
|---|---|---|---|---|---|
| 1^{st} Pass | 25.3 | 39.9 | 51.8 | 61.4 | 68 |
| Extraction (%) | | | | | |
| 2^{nd} Pass | 25.7 | 28.3 | 30.6 | 25.7 | N/A |
| Extraction (%) | | | | | |
| Total Extraction | 51 | 68.2 | 82.4 | 87.1 | 68 |
| (%) | | | | | |

As can be seen from FIG. 2, a 2 hr., two step extraction removes 51% of the lithium from the lithium-containing particles while a 2 hr., one step extraction removes only 39.9% of the lithium from the lithium-containing particles. Similarly, a 12 hr., two step extraction removes over 87% of the lithium while a 12 hr. one step extraction removes merely 68% of the lithium from the lithium-containing particles.

### Examples 3-7

In Examples 3-7, lithium-containing particles having the compositions described in Table 2 were each crushed until the population of crushed lithium-containing particles had a d10 of 1.9 μm, a d50 of 12 μm, and a d90 of 33.7 μm. The crushed lithium-containing particles were heat-treated at 500° C. for 4 hours. Then, 12 g of each of the heat-treated lithium-containing particles were separately mixed with 48 g of CaO powder and added to 600 ml of water. The weight ratio of lithium-containing particles to CaO was 1:4 and the solid to liquid volume ratio was 1:10. Each reaction was conducted at 100° C. with a stir rate of 300 RPM for 6 hr. Results are shown in Table 3 below.

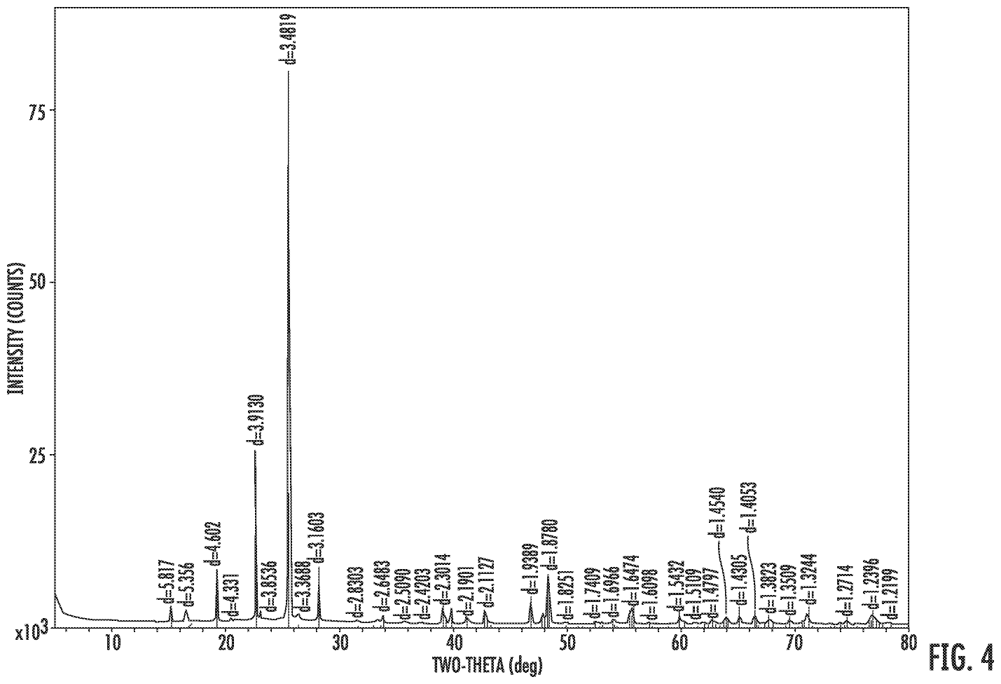

The residual solids from each extraction were heat-treated at 500° C. for 4 hours. Then, about 50 g of the heat-treated residual solids were mixed with 500 ml of water. The weight ratio of lithium-containing particles to CaO was 1:4 and the solid to liquid volume ratio was 1:10. The reaction was conducted at 100° C. with a stir rate of 300 RPM for a further 6 hr. Results are shown in FIG. 3 and Table 3.

TABLE 2

| | EX-3 | EX-4 | EX-5 | EX-6 | EX-7 |
|---|---|---|---|---|---|
| SiO₂ (wt. %) | 54.69 | 56.92 | 55.9116 | 52.8795 | 74.35 |
| Al₂O₃ (wt. %) | 28.31 | 24.831 | 22.5039 | 22.8929 | 7.56 |
| B₂O₃ (wt. %) | 6.63 | 6.55 | 4.5028 | 4.5639 | 0 |
| Li₂O (wt. %) | 4.96 | 4.44 | 3.9613 | 4.162 | 11.2 |
| Na₂O (wt. %) | 1.67 | 1.515 | 2.3982 | 1.9243 | 0.05 |
| K₂O (wt. %) | 0.267 | 0.29 | 0.7616 | 0.7719 | 0.12 |
| MgO (wt. %) | 2.77 | 1.259 | 8.2453 | 10.7025 | 0 |
| CaO (wt. %) | 0.503 | 3.76 | 0.4534 | 0.9191 | 0 |
| SrO (wt. %) | 0 | 0.0062 | 0.0002 | 0.0004 | 0 |
| BaO (wt. %) | 0 | 0.0018 | 0.0001 | 0.0002 | 0 |
| TiO₂ (wt. %) | 0 | 0.0128 | 0.0012 | 0.0011 | 0 |
| SnO₂ (wt. %) | 0.198 | 0.01 | 0.2437 | 0.247 | 0.02 |
| As₂O₃ (wt. %) | 0 | 0.0002 | 0 | 0 | 0 |
| P₂O₅ (wt. %) | 0 | 0 | 0.0528 | 0.0555 | 2.09 |
| ZrO₂ (wt. %) | 0 | 0.008 | 0.8966 | 0.8078 | 4.31 |
| Fe₂O₃ (wt. %) | 0 | 0.018 | 0.0675 | 0.0719 | 0.06 |
| HfO₂ (wt. %) | 0 | 0 | 0 | 0 | 0.08 |
| Co₃O₄ (wt. %) | 0 | 0.0114 | 0 | 0 | 0 |
| Cr₂O₃ (wt. %) | 0 | 0.0677 | 0 | 0 | 0 |
| CuO (wt. %) | 0 | 0.2924 | 0 | 0 | 0 |
| NiO (wt. %) | 0 | 0.01 | 0 | 0 | 0 |
| Sb₂O₃ (wt. %) | 0 | 0.0012 | 0 | 0 | 0 |
| ZnO (wt. %) | 0 | 0.0008 | 0 | 0 | 0 |
| Acid Chemical | 35.97 | 20.05 | Not | Not | 0.03 |
| Durability (mg/cm² | | | Tested | Tested | |
| weight loss) | | | | | |
| Alkaline Chemical | 3.24 | 2.24 | Not | Not | 0.30 |
| Durability (mg/cm² | | | Tested | Tested | |
| weight loss) | | | | | |

TABLE 3

| | EX-3 | EX-4 | EX-5 | EX-6 | EX-7 |
|---|---|---|---|---|---|
| 1^{st} Pass | 61.4 | 48.9 | 37.2 | 35.1 | 17.9 |
| Extraction % | | | | | |
| 2^{nd} Pass | 25.8 | 28.9 | 24.6 | 20.7 | 16.4 |
| Extraction % | | | | | |
| Total | 87.2 | 77.8 | 61.8 | 55.8 | 34.3 |
| Extraction % | | | | | |

As can be seen from Table 2 and FIG. 3, glass compositions with lower chemical durability yielded more efficient lithium extraction in each of the first and second passes. Low chemical durability glass, such as EX-3, resulted in 87.2% of lithium removal after the second pass.

### Example 8

In Example 8, lithium containing particles having the composition of Example 3 in Table 2 were crushed until the population of crushed lithium-containing particles had a d10 of 1.9 μm, a d50 of 12 μm, and a d90 of 33.7 μm. The crushed lithium-containing particles were heat-treated at 1100° C. for 4 hours to make a β-spodumene containing glass-ceramic. A sample of the heat-treated glass-based fines was subjected to X-ray diffraction (XRD) analysis, the results are shown in FIG. 4. As depicted in FIG. 4, heat treatment of the glass-based fines resulted in complete conversion of the glass-based fines to β-spodumene glass-ceramic.

Then, 12 g of the glass-ceramic particles were mixed with 48 g of CaO powder and added to 600 ml of water. The weight ratio of lithium-containing particles to CaO was 1:4 and the solid to liquid volume ratio was 1:10. The reaction was conducted at 100° C. with a stir rate of 300 RPM for 12 hours.

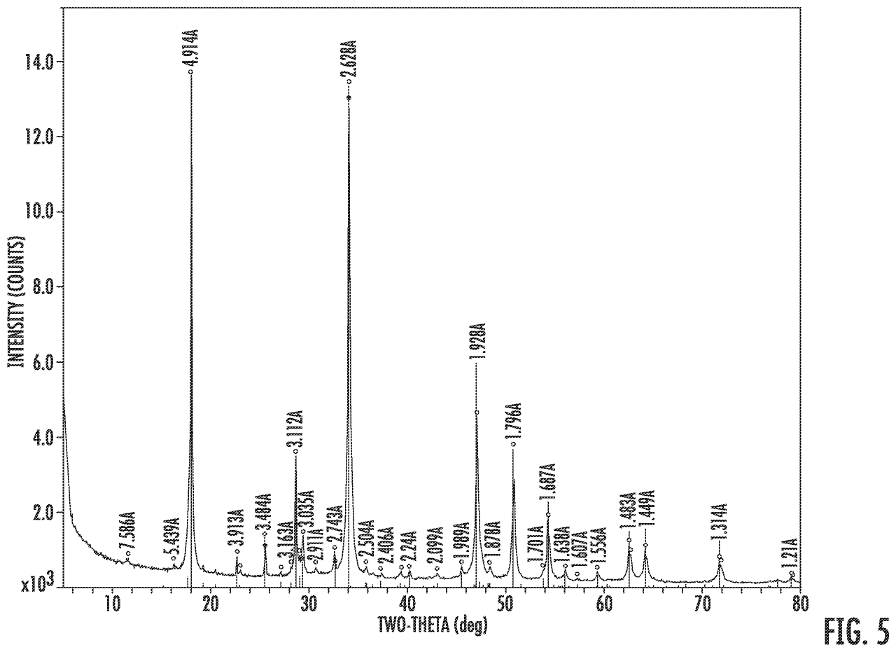

After the extraction process, a sample of the residual solids was again subjected to XRD, the results of which are shown in FIG. 5. As can be seen by comparing FIGS. 4 and 5, nearly all the lithium aluminum silicate has been removed.

Example 8 resulted in the extraction of 27 wt. % of the lithium originally in the glass-based fines after a 12 hr., single pass extraction. The comparable 12 hr., single pass extraction of Example 1 resulted in the extraction of 68 wt. % of the lithium initially in the glass-based fines, showing that extraction from glass may be more efficient than extraction from glass ceramics in some cases. Without being limited by theory, it is believed that difference in extraction efficiency may be due to the higher chemical durability of glass ceramics in certain phase assemblages, relative to the chemical durability of glass.

While embodiments and examples have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

What is claimed is:

1. A process for recovering lithium from lithium-containing glass, the process comprising:
providing lithium-containing particles comprising the lithium-containing glass;
contacting the lithium-containing particles with calcium salts in water at a first leaching temperature for a first leaching time to produce a first mixture, wherein the contacting causes leaching of at least a portion of lithium ions from the lithium-containing particles into a first leachate of the first mixture;
separating the first mixture into the first leachate and a first residue;
heat treating the first residue to form a heat-treated residue comprising partially leached lithium-containing particles and calcium oxide;
contacting the heat-treated residue with water at a second leaching temperature for a second leaching time, wherein the contacting causes leaching of lithium ions from the partially leached lithium-containing particles in a second leachate of a second mixture;
separating the second mixture into the second leachate and a second residue; and
recovering lithium from the first leachate, the second leachate, or both.

2. The process of claim 1, wherein the lithium-containing particles comprise low chemical durability glass particles and the lithium-containing particles have an acid chemical durability of greater than 15 mg/cm² weight loss after 24 hours of exposure to 5 wt. % HCl, based on the initial weight and surface area of the lithium-containing particles, an alkaline chemical durability of greater than 1.5 mg/cm² weight loss after 6 hours of exposure to 5 wt. % NaOH, based on the initial weight and surface area of the lithium-containing particles, or both.

3. The process of claim 1, wherein the lithium-containing particles comprise a median particle size (d50) of from about 10 μm to about 150 μm.

4. The process of claim 1, wherein the process further comprises heat treating the lithium-containing particles at a temperature of from 500° C. to 700° C. prior to contacting the lithium-containing particles with the calcium salts and water, wherein the heat treating removes residual organic compounds from the lithium-containing particles, dries the lithium-containing particles, or both.

5. The process of claim 1, wherein the lithium-containing particles have less than about 5% crystallinity.

6. The process of claim 1, wherein the lithium-containing particles have a composition comprising:
from 30 mol % to 85 mol % SiO₂;
from 2 mol % to 30 mol % Al₂O₃;
from 0 mol % to 20 mol % B₂O₃;
from 2 mol % to 20 mol % Li₂O;
from 0 mol % to 20 mol % Na₂O;
from 0 mol % to 20 mol % K₂O;
from 0 mol % to 20 mol % MgO;
from 0 mol % to 20 mol % CaO;
from 0 mol % to 10 mol % SrO;
from 0 mol % to 10 mol % BaO;
from 0 mol % to 5 mol % ZrO₂;
from 0 mol % to 5 mol % TiO₂; and
from 0 mol % to 5 mol % SnO₂.

7. The process of claim 1, wherein the lithium-containing particles comprise less than 8 mol % of a combined weight of MgO and ZrO₂, based on the total moles of glass in the lithium-containing particles.

8. The process of claim 1, wherein the first leaching temperature, the second leaching temperature, or both is from 80° C. to 120° C.; and the first leaching time, the second leaching time, or both is from 1 to 12 hours.

9. The process of claim 1, wherein the process removes at least 75% of the lithium from the lithium-containing particles.

10. The process of claim 1, wherein
recovering lithium from the first leachate, the second leachate, or both comprises precipitating lithium salts from the first leachate, the second leachate, or both; and
precipitating lithium salts from the first leachate, the second leachate, or both comprises adding a precipitating agent to the first leachate, the second leachate, or both, wherein the precipitating agent comprises sodium carbonate, sodium phosphate, or both and the lithium salts comprise lithium carbonate, lithium sodium phosphate, lithium phosphate, or combinations thereof.

11. The process of claim 1, wherein the heat treating the first residue comprises exposing the first residue to a temperature of from 400° C. to 700° C.

12. The process of claim 1, where a weight ratio of lithium-containing particles to calcium salts in the first mixture, the second mixture, or both is from 1:1 to 1:8.

13. The process of claim 1, where a weight ratio of solids to liquids in the first mixture, the second mixture, or both is from 1:5 to 1:15.

14. The process of claim 1, further comprising, while contacting the lithium-containing particles with the calcium salts in the water at the first leaching temperature, condensing water vapor to produce condensed water and returning the condensed water back into contact with the lithium-containing particles and the calcium salts.

15. The process of claim 1, where a pH in the first mixture, the second mixture, or both is from 10.5 to 12.

16. The process of claim 1, where the calcium salts comprise CaO.

17. A process for recovering lithium from lithium-containing glass ceramics, the process comprising:
providing lithium-containing particles comprising the lithium-containing glass ceramics;
contacting the lithium-containing particles with calcium salts in water at a first leaching temperature for a first leaching time to produce a first mixture, wherein the contacting causes leaching of at least a portion of lithium ions from the lithium-containing particles into a first leachate of the first mixture;
separating the first mixture into the first leachate and a first residue;
heat treating the first residue to form a heat-treated residue comprising partially leached lithium-containing particles and calcium oxide;
contacting the heat-treated residue with water at a second leaching temperature for a second leaching time, wherein the contacting causes leaching of lithium ions from the partially leached lithium-containing particles in a second leachate of a second mixture;
separating the second mixture into the second leachate and a second residue; and
recovering lithium from the first leachate, the second leachate, or both; wherein the lithium-containing glass ceramics comprise one or more of a lithium disilicate phase, a petalite bearing phase, a β-spodumene phase, or combinations thereof.

18. The process of claim 17, wherein the lithium-containing particles comprise a median particle size (d50) of from about 10 μm to about 150 μm.

19. The process of claim 17, wherein
a weight ratio of lithium-containing particles to calcium salts in the first mixture, the second mixture, or both is from 1:1 to 1:8; and
a weight ratio of solids to liquids in the first mixture, the second mixture, or both is from 1:5 to 1:15.

20. The process of claim 17, where a pH in the first mixture, the second mixture, or both is from 10.5 to 12.
